(19) United States
(12) Patent Application Publication
(10) Pub. No.: US 2014/0141207 A1
(43) Pub. Date: May 22, 2014

(54) PROTECTIVE FILM

(71) Applicants: FIH (Hong Kong) Limited, Kowloon (HK); SHENZHEN FUTAIHONG PRECISION INDUSTRY CO., LTD., Shenzhen (CN)

(72) Inventors: CHIH-WEI CHANG, New Taipei (TW); TUO LIU, Shenzhen (CN)

(73) Assignees: FIH (HONG KONG) LIMITED, Kowloon (HK); SHENZHEN FUTAIHONG PRECISION INDUSTRY CO., LTD., Shenzhen (CN)

(21) Appl. No.: 13/949,908

(22) Filed: Jul. 24, 2013

(30) Foreign Application Priority Data
Nov. 19, 2012 (CN) 2012206122390

(51) Int. Cl. C09J 7/02

(52) U.S. Cl. CPC C09J 7/02
USPC 428/177; 428/174

(57) ABSTRACT

A protective film for an object includes an adhesive portion and an operating portion. The adhesive portion is adhered to the object. The operating portion is integrally formed with the adhesive portion. The operating portion includes a number of spaced-apart protrusions protruding from the operating portion and facing the object.

### BACKGROUND

1. Technical Field

The exemplary disclosure generally relates to protective films, and particularly to a protective film that can be easily removed.

2. Description of Related Art

In some steps for manufacturing or transporting a portable electronic device, a protective film is bonded onto a display and a housing of the portable electronic device to protect the display and the housing from being scraped or soiled before sale and use. In use, the protective film must be removed from the portable electronic device. However, it can be difficult for end users to peal off the protective film.

Therefore, there is room for improvement within the art.

### BRIEF DESCRIPTION OF THE DRAWINGS

Many aspects of the embodiments can be better understood with reference to the drawings. The components in the drawings are not necessarily drawn to scale, the emphasis instead being placed upon clearly illustrating the principles of the disclosure.

FIG. 1 shows an isometric view of an exemplary embodiment of a protective film.

FIG. 2 is similar to the FIG. 1, but showing an enlarged view of a part of the protective film.

### DETAILED DESCRIPTION

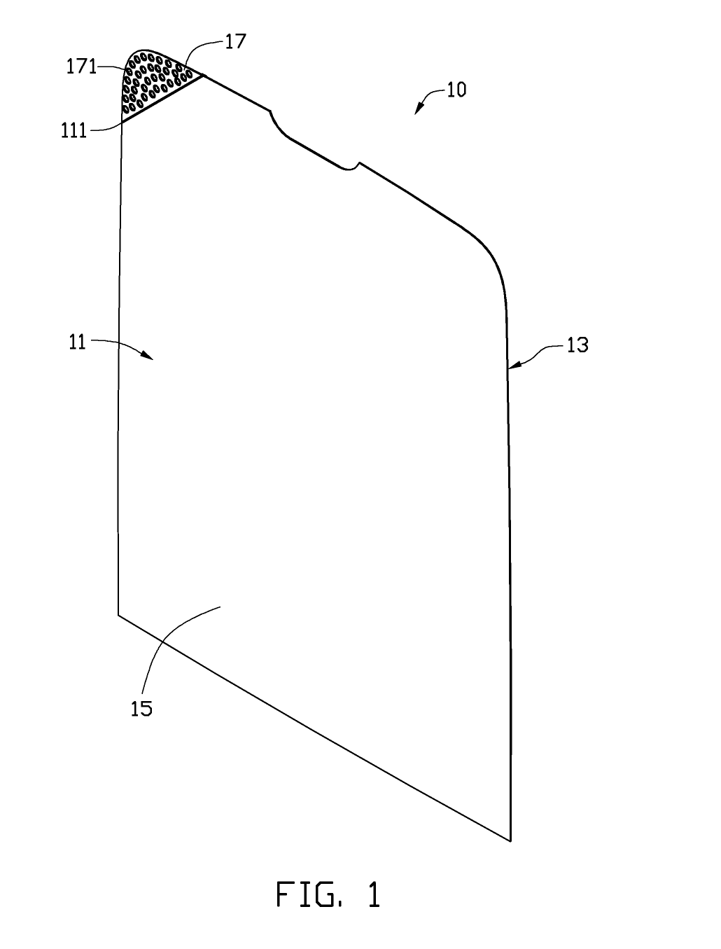

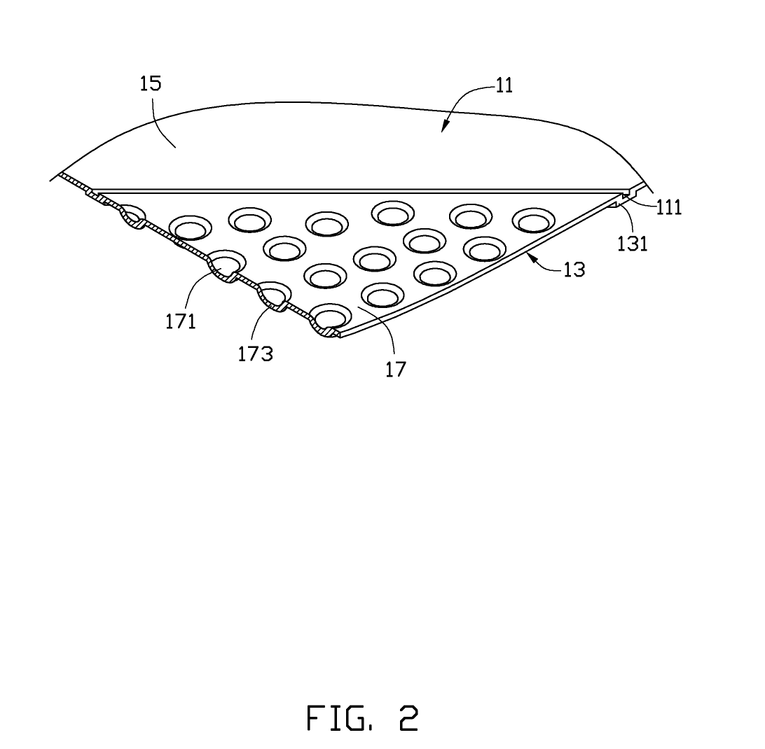

FIG. 1 shows an isometric view of an exemplary embodiment of a protective film 10. FIG. 2 is similar to the FIG. 1, but showing an enlarged view of a part of the protective film 10. The protective film 10 is bonded onto an object, such as a housing or a display of a portable electronic device.

The protective film 10 includes a first surface 11, a second surface 13 opposite to the first surface 11, an adhesive portion 15, and an operating portion 17 connected to the adhesive portion 15. The first surface 11 defines a slot 111 disposed between the adhesive portion 15 and the operating portion 17. In other words, the slot 111 divides the protective film 10 into the adhesive portion 15 and the operating portion 17 that is integrally formed with the adhesive portion 15. In the exemplary embodiment, the slot 111 extends to two adjacent side edges of the protective film 10, such that the operating portion 17 is formed at a corner of the protective film 10. The second surface is adhesive or viscous. The protective film 10 further includes a flange 131 protruding from the second surface 13. The flange 131 is aligned with the slot 111 to increase a thickness of a portion of the protective film 10 where the slot 111 is defined.

The operating portion 17 includes a plurality of spaced-apart recesses 171 and a plurality of spaced-apart protrusions 173 arranged corresponding to the spaced-apart recesses 171. The recesses 171 are defined in the first surface 11, and the protrusions 173 protrude from the second surface 13 accordingly. Each protrusion 173 has an adhesive surface. Each protrusion 173 can have an arcuate or rectangular-solid shape. The recesses 171 and the protrusions 173 can be manufactured by, but is not limited to, a method such as stamping. A tool (not shown) presses the operating portion 17 on the first surface 11 to form a portion of the operating portion 17 to be recessed from the first surface 11 towards the second surface 13, thereby forming the recesses 171 on the first surface 11, and forming the protrusions 173 on the second surface 13 accordingly.

In use, the second surface 13 of the protective film 10 is bonded onto the object, since the slot 111 and the recesses 171 are defined in the first surface 11 and facing a user, the user can easily distinguish the operating portion 17 from the adhesive portion 15, and peel off the protective film 10 from the object by grasping the operating portion 17. In addition, each protrusion 173 has an adhesive surface and can adhere to the object, which increases adherence between the protective film 10 and the objects so that the protective film 10 is not accidentally removed or knocked off. Furthermore, because the protrusions 173 protrude from the second surface 13, only a top of each protrusion 173 is adhered to the object, such that an adhesion area between each protrusion 173 and the object is decreased, making it easier to use the operating portion 17 to peel away the protective film 10 from the object.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A protective film, comprising:
an adhesive portion; and
an operating portion integrally formed with the adhesive portion, the operating portion comprising a plurality of spaced-apart protrusions protruding from the operating portion.

2. The protective film of claim 1, further comprising a first surface and a second surface opposite to the first surface, wherein the second surface is adhesive, and the protrusions protruding from the second surface.

3. The protective film of claim 2, further comprising a slot defined in the first surface, wherein the protective film is divided into the adhesive portion and the operating portion by the slot.

4. The protective film of claim 3, wherein the slot is extended to two adjacent side edges of the protective film, the operating portion is formed at a corner of the protective film.

5. The protective film of claim 3, further comprising a flange protruding from the second surface and aligning with the slot, wherein the flange increases a thickness of a portion of the protective film where the slot is defined.

6. The protective film of claim 2, wherein the operating portion further comprises a plurality of recesses defined in the first surface, the plurality of recesses are arranged according to the plurality of protrusions.

7. The protective film of claim 2, wherein each protrusion has an adhesive surface.

8. The protective film of claim 1, wherein each protrusion has an arcuate or rectangular-solid shape.

9. A protective film for an object, comprising:
an adhesive portion adhered to the object; and
an operating portion integrally formed with the adhesive portion, the operating portion comprising a plurality of spaced-apart protrusions protruding from the operating portion and facing the object.

10. The protective film of claim 9, further comprising a first surface and an second surface opposite to the first surface, wherein the second surface is adhered to the object, the protrusions protruding from the second surface.

11. The protective film of claim 10, further comprising a slot defined in the first surface, wherein the protective film is divided into the adhesive portion and the operating portion by the slot.

12. The protective film of claim 11, wherein the slot is extended to two adjacent side edges of the protective film, the operating portion is formed at a corner of the protective film.

13. The protective film of claim 11, further comprising a flange protruding from the second surface and aligning with the slot, wherein the flange increases a thickness of a portion of the protective film where the slot is defined.

14. The protective film of claim 10, wherein the operating portion further comprises a plurality of recesses defined in the first surface, the plurality of recesses are arranged according to the plurality of protrusions.

15. The protective film of claim 10, wherein each protrusion has an adhesive surface.

16. The protective film of claim 9, wherein each protrusion has an arcuate or a rectangular-solid shape.

17. A protective film, comprising:
an adhesive portion; and
an operating portion connected to the adhesive portion, the operating portion comprising a plurality of spaced-apart protrusions protruding from the operating portion.

18. The protective film of claim 17, further comprising a first surface, a second surface opposite to the first surface, and a slot defined in the first surface, wherein the second surface is adhesive, and the protrusions protruding from the second surface; the protective film is divided into the adhesive portion and the operating portion by the slot.

19. The protective film of claim 18, further comprising a flange protruding from the second surface and aligning with the slot, wherein the flange increases a thickness of a portion of the protective film where the slot is defined.

20. The protective film of claim 19, wherein the operating portion further comprises a plurality of recesses defined in the first surface, the plurality of recesses are arranged according to the plurality of protrusions.
